(19) United States
(12) Patent Application Publication
(10) Pub. No.: US 2008/0177436 A1
(43) Pub. Date: Jul. 24, 2008

(54) Diagnostic and telematic system

(76) Inventor: Frederick O. Fortson, Whitmore Lake, MI (US)

Correspondence Address: Michael T. Raggio;Raggio & Dinnin, P.C., Ste. 410, 2701 Cambridge Court, Auburn Hills, MI, 48326, US

(21) Appl. No.: 11/986,354

(22) Filed: Nov. 21, 2007

Related U.S. Application Data
(60) Provisional application No. 60/866,982, filed on Nov. 22, 2006.

(51) Int. Cl. G01M 17/00; G01C 21/00; G01S 5/00; B60Q 1/54

(52) U.S. Cl. 701/29; 701/216; 340/467; 340/425.5

(57) ABSTRACT

A communication system for use within a vehicle, between vehicles and other remotely located devices is disclosed. The communication system includes a control hub for managing and analyzing multiple incoming wireless and wired data streams. The system also includes at least one sensor module wirelessly in communication with the control hub. A sensor control panel interface may be used for reviewing information from the sensor modules and a distributed mesh network may be used for supporting at least two levels therein. The communication system may be wirelessly based and may be built for rugged harsh environments such as those found in military applications and other harsh industrial applications.

This application claims the benefit of provisional application 60/866,982 filed Nov. 22, 2006

### BACKGROUND OF THE INVENTION

1. Field of the Invention

The present invention generally relates to a communication system and more particularly relates to a diagnostic and telematic communication system for use between platforms, mobile or stationary and wireless sensors.

2. Description of Related Art

Communication devices within vehicles have been known for many years. Most of these communication devices rely on wired networks that operate on a CAN protocol or similar system. These CAN systems allow for various vehicle functions to be monitored by a central computer in the vehicle to allow for decisions to be made in the vehicle environment regarding safety systems, engine control parameters, and the like. However, many of these prior art in vehicle communication systems may have trouble operating in rugged noisy environments, such as those found in battle fields and other high intensity environments.

Therefore, there is a need in the art for a rugged wireless communication system that is capable of incorporating prior art wired legacy communication systems into an overall system to allow for intra vehicle communication and inter vehicle communication via control hubs to allow for real time processing of information in a military vehicle and other harsh environment vehicle operation. There also is a need in the art for a sensor module that is rugged, durable and operates at low power to allow for sensing of vibration and inertial parameters in violent environments such as in a military battle field, and other harsh environmental applications. There also is a need in the art for a communication system that is capable of communicating between vehicles and with portable devices such as maintenance devices to allow for a remote third party to advise the operator of the vehicles to be advised of maintenance needed or of real time information on the battle field or other harsh environments. There also is a need in the art for a mesh network that operates at two levels, i.e., micro mesh level and a marco mesh level to allow for real time coordination and control of a plurality of sensors within a military vehicle environment, however any other environment may also use the present invention such as but not limited to any industrial application, steel mills, oil rigs, wind farms, etc.

### SUMMARY OF THE INVENTION

One object of the present invention may be to provide an improved diagnostic and telematic system.

Another object of the present invention may be to provide an improved diagnostic and telematic system that connects vehicles in real time and operates on a two level network system.

Yet a further object of the present invention may be to provide a plurality of highly durable sensor modules that communicate with a highly durable control hub on military vehicles and other military devices.

Still a further object of the present invention may be to provide a sensor control panel software and/or hardware viewer within a distributed mesh network to allow for real time communication in a plurality of vehicles.

Yet another object of the present invention may be to provide a methodology of coordinating and controlling both wired and wireless sensors within a vehicle and between a network of vehicles.

To achieve the foregoing objects, a communication system for use within a vehicle, between vehicles and other remotely located devices is disclosed. The system includes a control hub for managing and analyzing multiple incoming wireless and wired data streams. The system also includes at least one sensor module in communication with the control hub. The system also includes a sensor control panel interface for viewing information from the sensor modules. The system also includes a distributed mesh network having at least two levels.

One advantage of the present invention may be that the diagnostic and telematic communication system allows for wireless sensors to communication with the a control hub in harsh environments.

A further advantage of the present invention may be that it allows for the use of a sensor control panel viewer in a communication system of a military vehicle.

Still another advantage of the present invention is that it may provide for the use of a distributed mesh network having both a micromesh level and a macro mesh level between vehicles and portable devices in harsh environments.

Yet another advantage of the present invention may be that it provides real time location and sensing data to military vehicles in a battle field environment.

Yet another advantage of the present invention may be the ability to operate a communication system at low voltages using both GPS technology and an accelerometer therein.

Yet another advantage of the present invention may be the ability to compare input data values with a set of arbitrary dataset rules for the purpose of performing the triggering of a consequential action or pre-programmed device behavior, i.e., Event Sensitive Triggering.

Yet another advantage of the present invention may be the ability to locally aggregate vehicle data in non-volatile storage media, such as but not limited to a flash memory, etc., to capture network, analog, and digital signals and events independently of a separate On Board Computing (PC) platform.

Yet another advantage of the present invention may be the ability to filter and to convert into engineering units aggregated data, via a control hub of the present invention without the need of computing power on a separate or remote computer, so it may be presented to other data processing devices in self describing metadata format such as XML for the purpose of abstracting the data from its source data type and retrieval methodology.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a block diagram of a communication system architecture according to the present invention.

FIGS. 2a and 2b show a sensor control hub and GPS telematics unit for use in a communication system according to the present invention.

FIGS. 3a and 3b show a sensor module for use in a communication system according to the present invention.

FIGS. 4a and 4b show a sensor control panel user interface for use in a communication system of the present invention.

FIG. 5 shows a plurality of networking topologies capable of being used by the communication system of the present invention.

FIG. 6 shows a communication system showing micro and macro mesh networks according to the present invention.

FIGS. 7a and 7b show a control hub for use in the network system according to the present invention.

FIG. 8 shows a control hub mounted in a vehicle according to the present invention.

FIG. 9 shows a control hub in block diagram form for use in a vehicle according to the present invention.

FIG. 10 shows a block diagram from the network system according to the present invention.

FIG. 11 shows a block diagram of a wireless sensor module according to the present invention.

FIG. 12 shows a block diagram of a personal remote pendant device for use in the present invention.

FIG. 13 shows a block diagram of a vehicle mounted display device for use in the present invention.

FIG. 14a through 14b show ultrasonic consolidation through direct embedding of rugged RS devices and sensor modules according to the present invention.

FIG. 15 shows the architecture diagram of a communication system according to the present invention.

FIG. 16 shows a visual diagram of the communication system according to the present invention.

FIG. 17 shows a platform diagram of a communication system according to the present invention.

FIG. 18 shows a battle field diagram of the communication system according to the present invention.

FIG. 19 shows a diagram of a control hub using both GPS and dead reckoning technology according to the present invention.

FIG. 20 shows a block diagram of a handheld unit for use in the battle field environment by individual personnel.

FIG. 21 shows a graph of a personal handheld device for use by soldiers within the communication system of the present invention.

FIG. 22 shows a block diagram of the system according to the present invention.

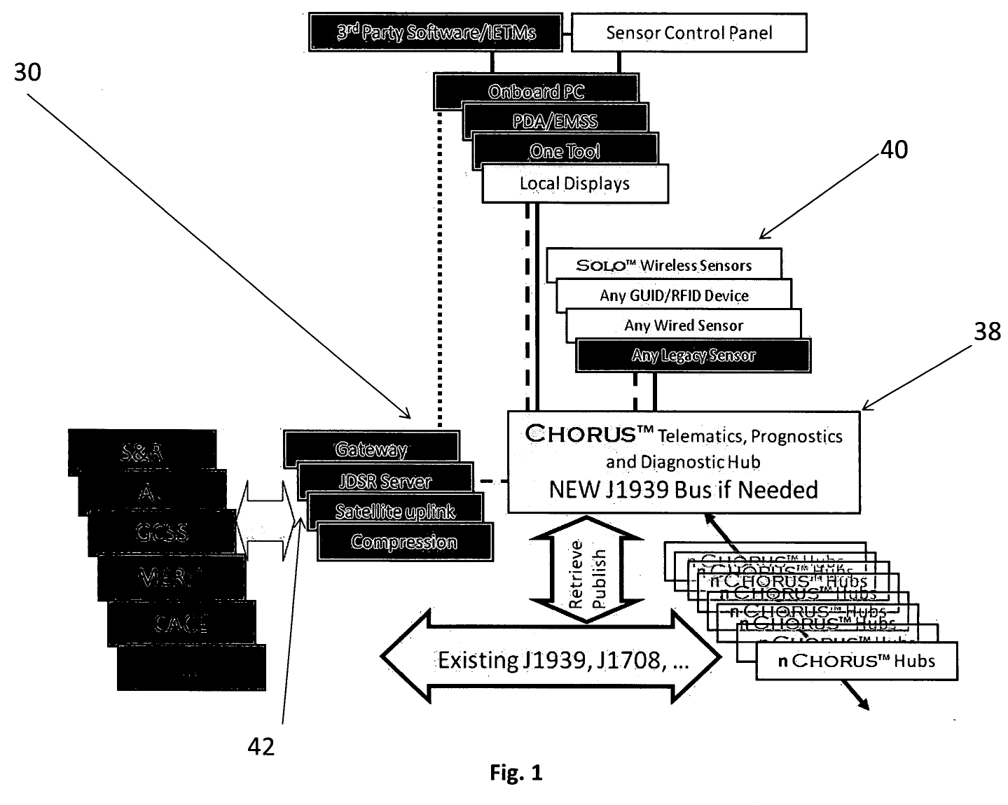

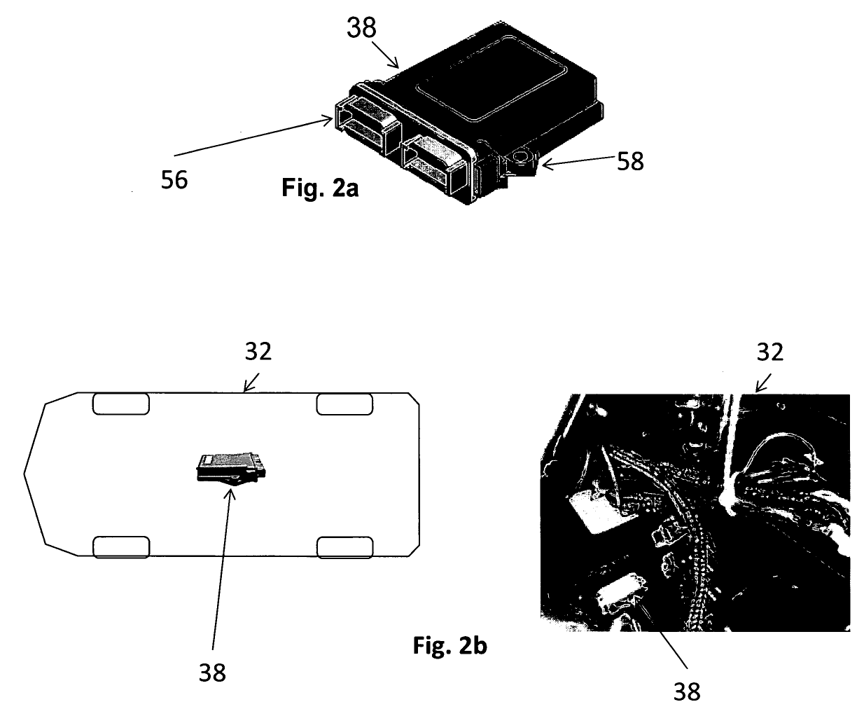

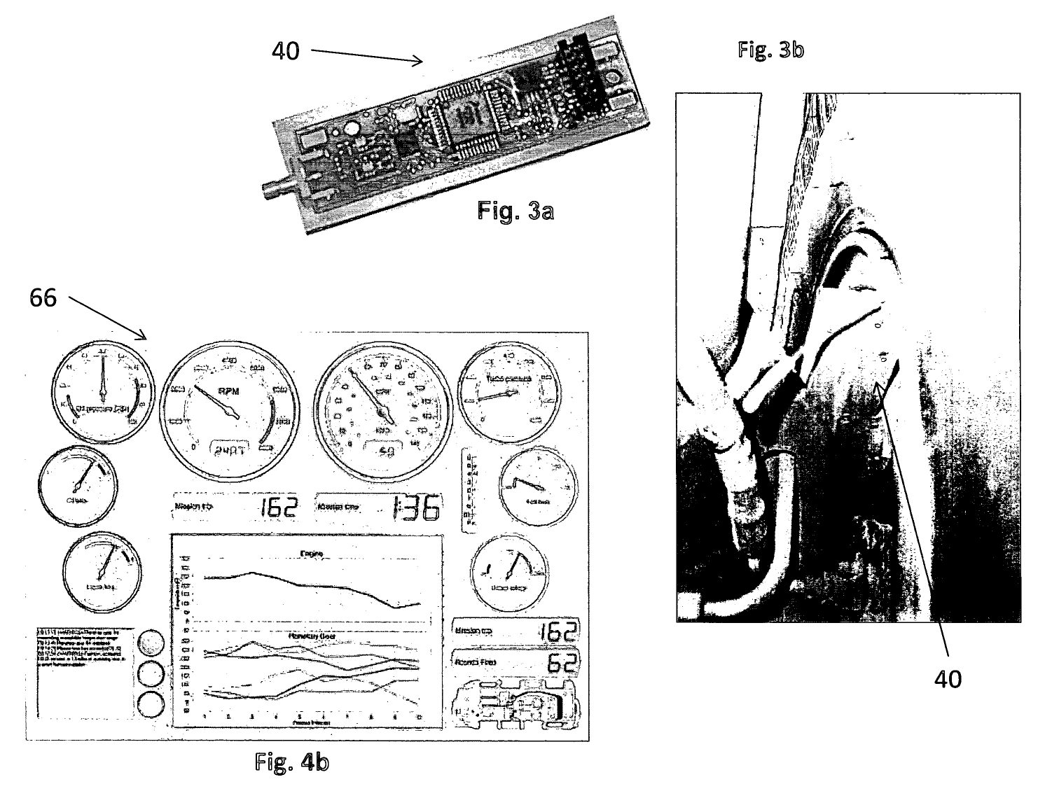

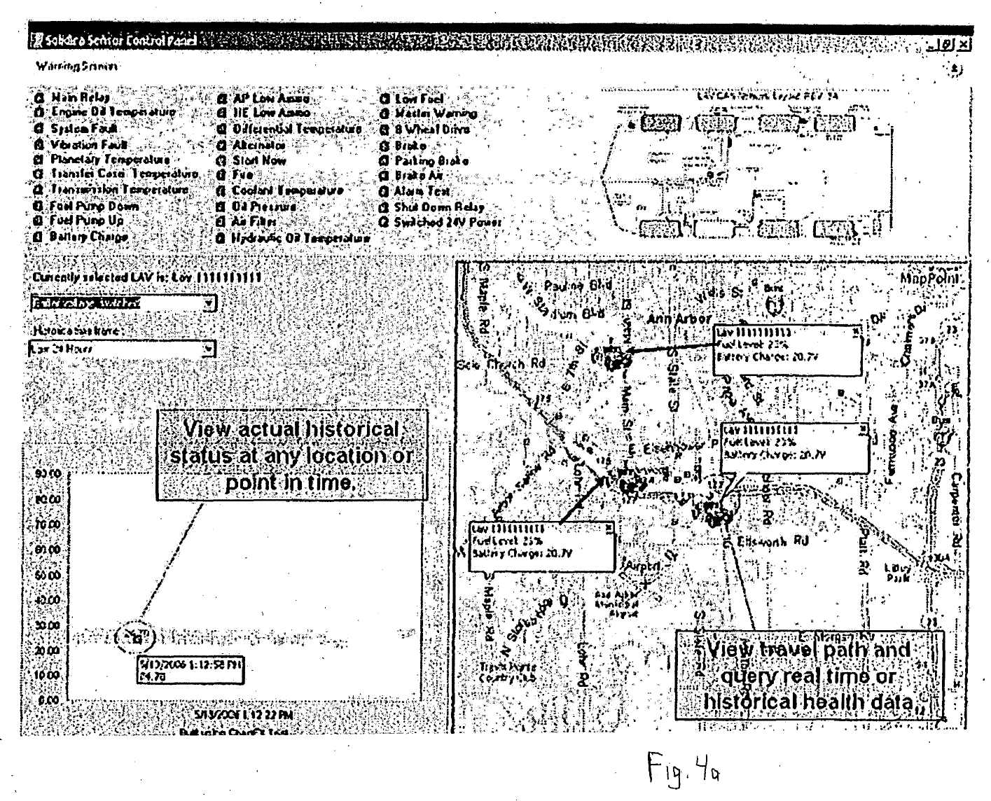

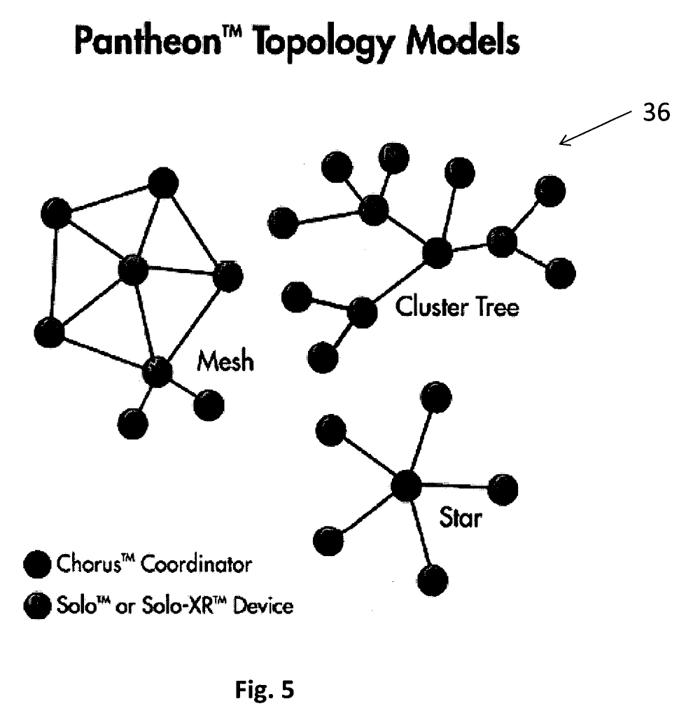

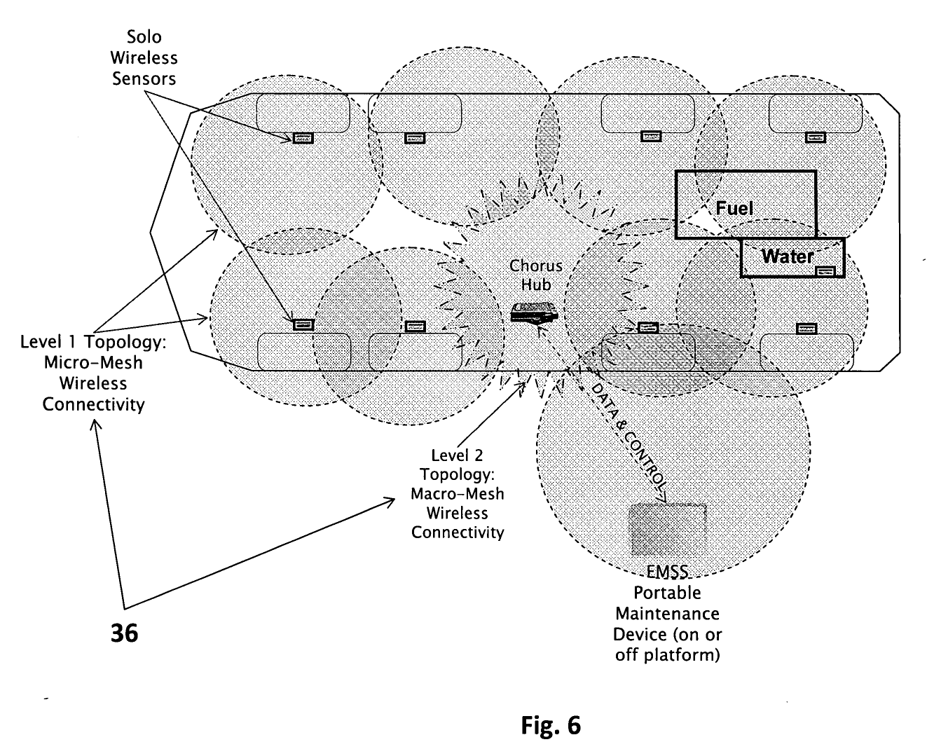

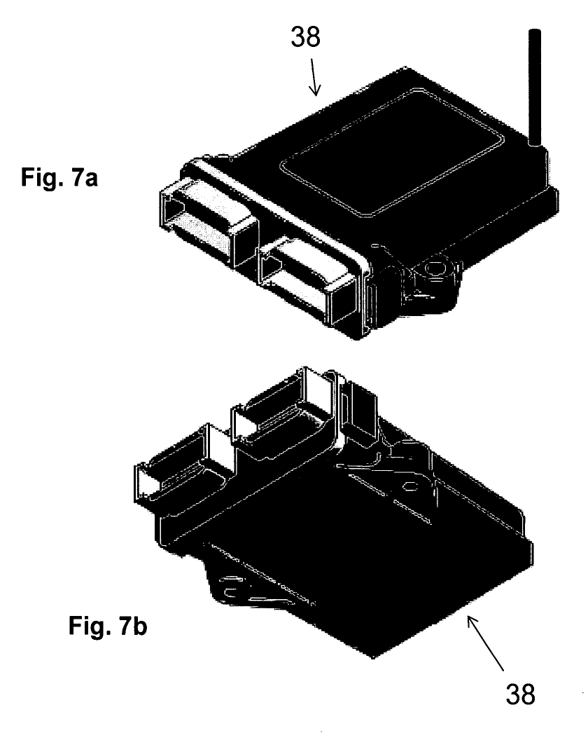

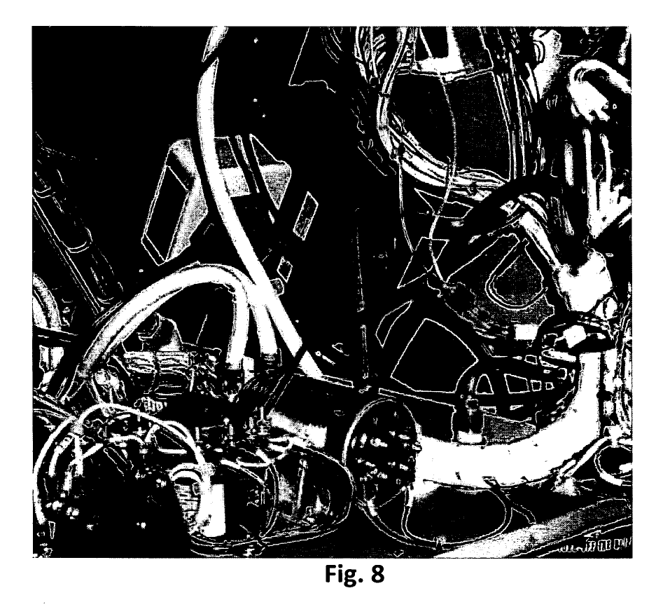

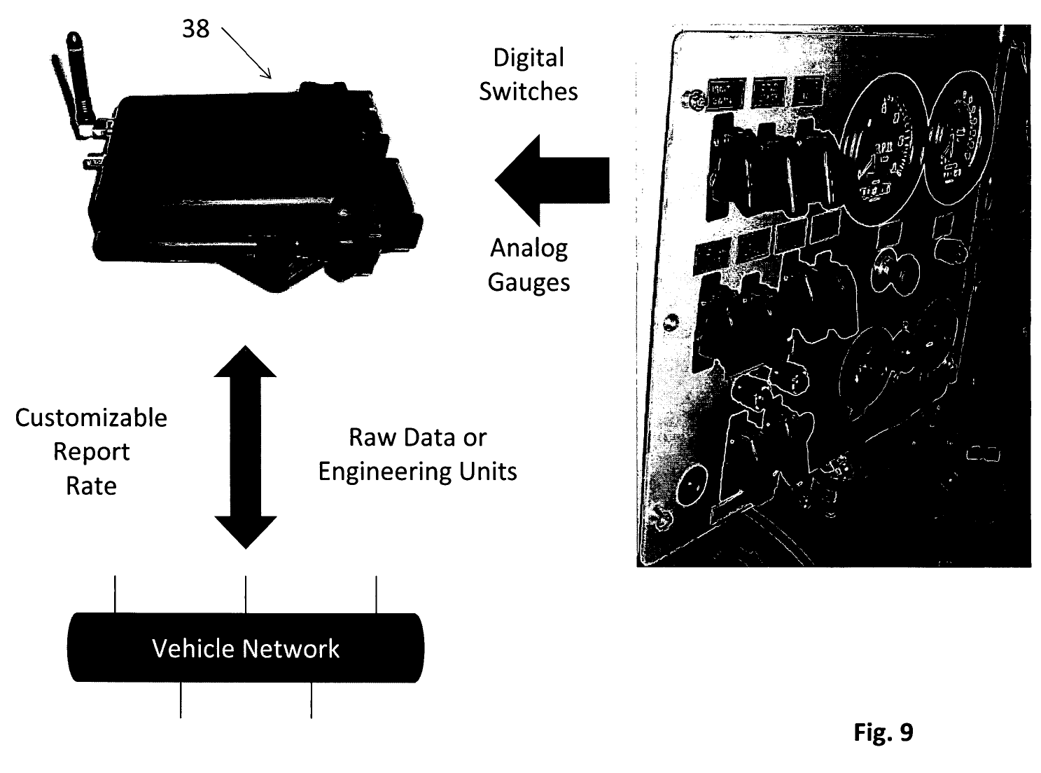

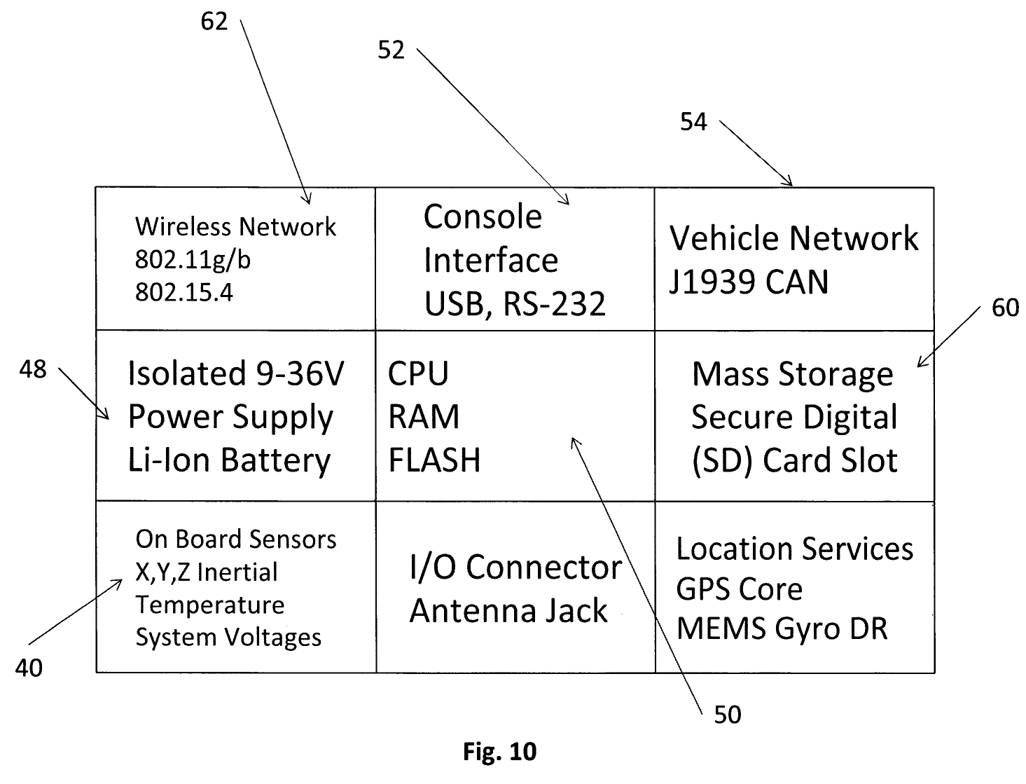

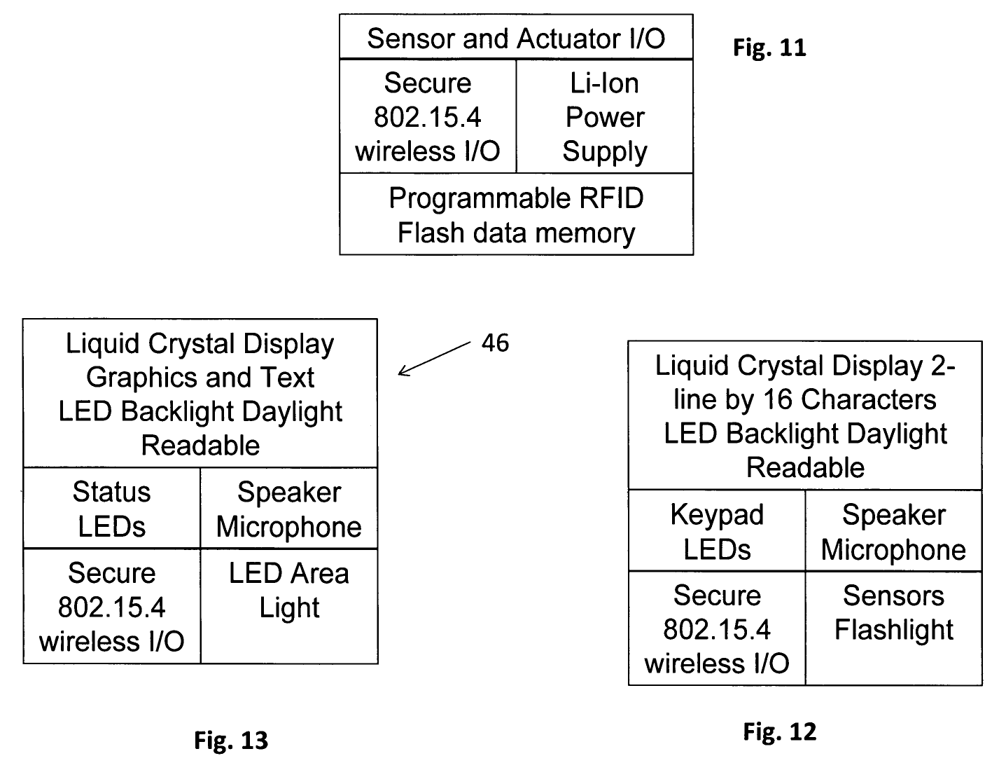

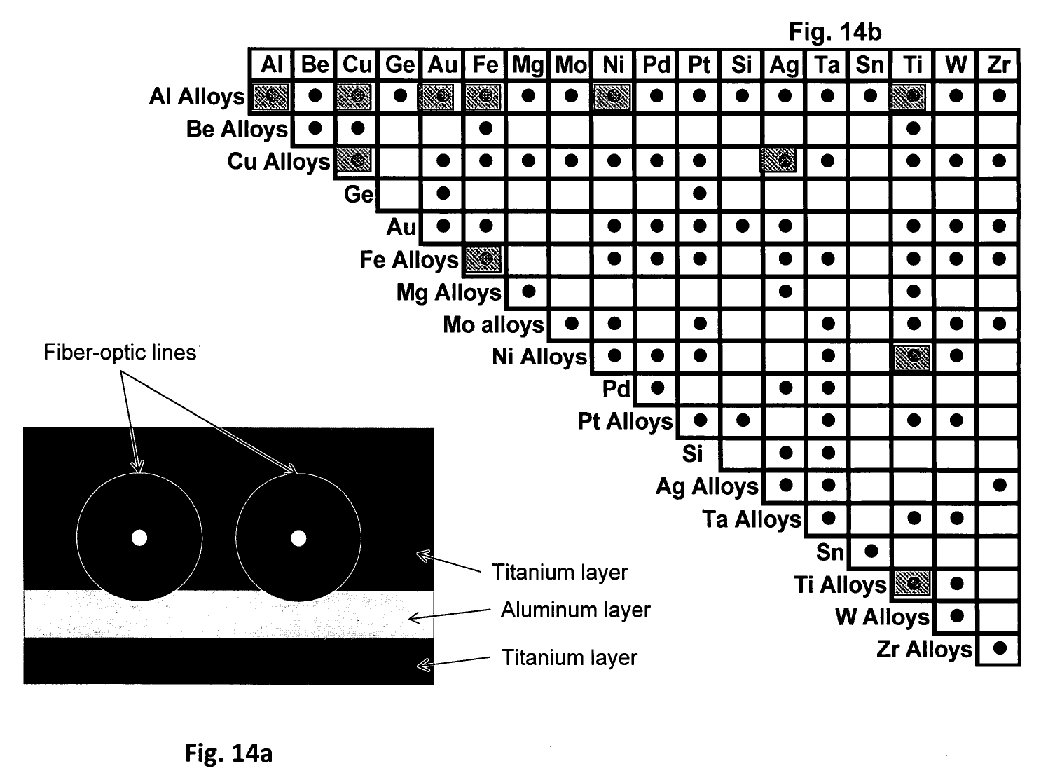

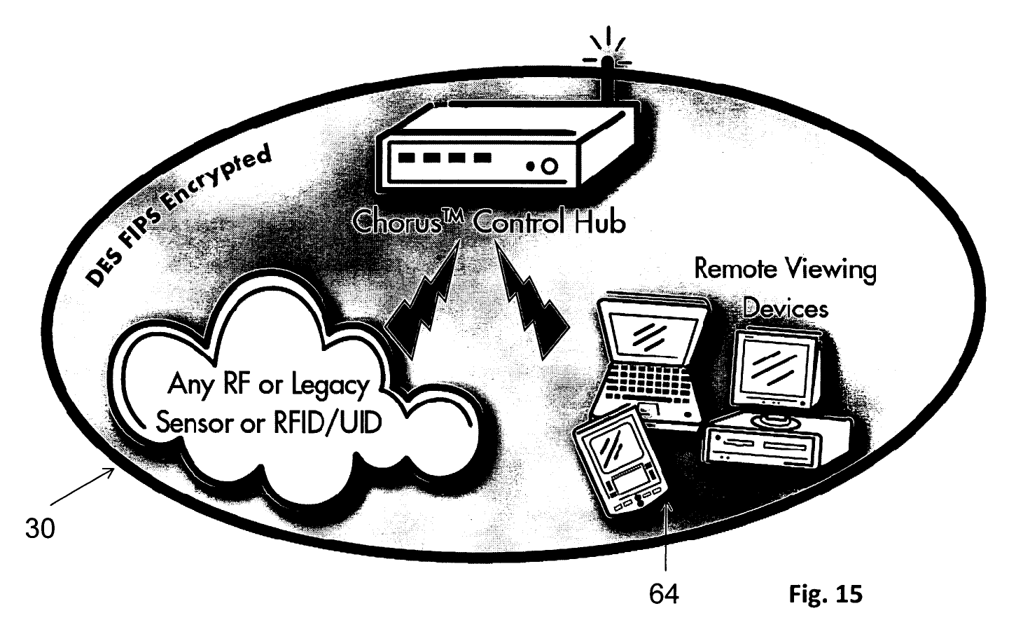

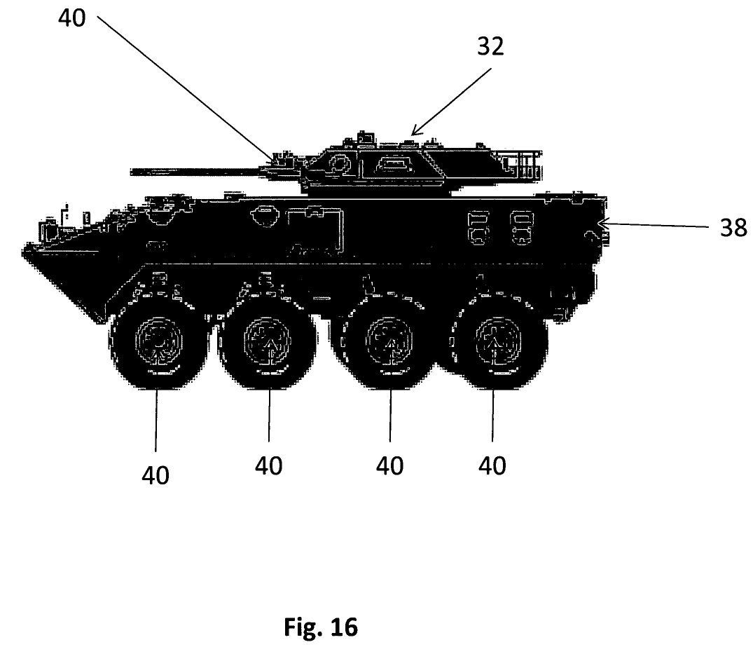

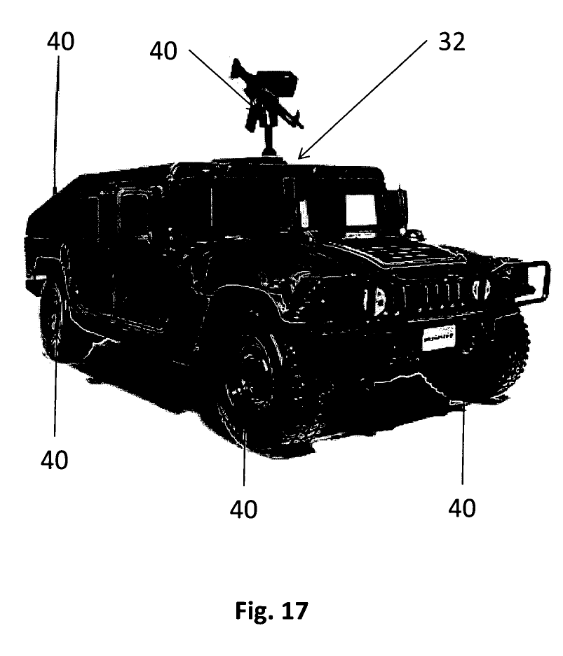

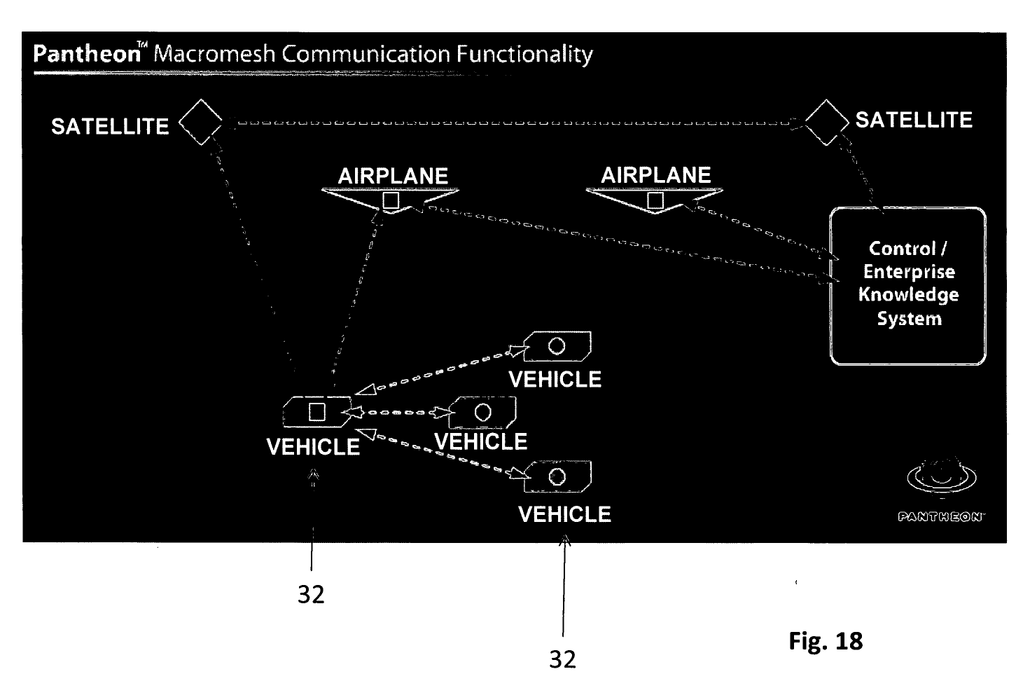

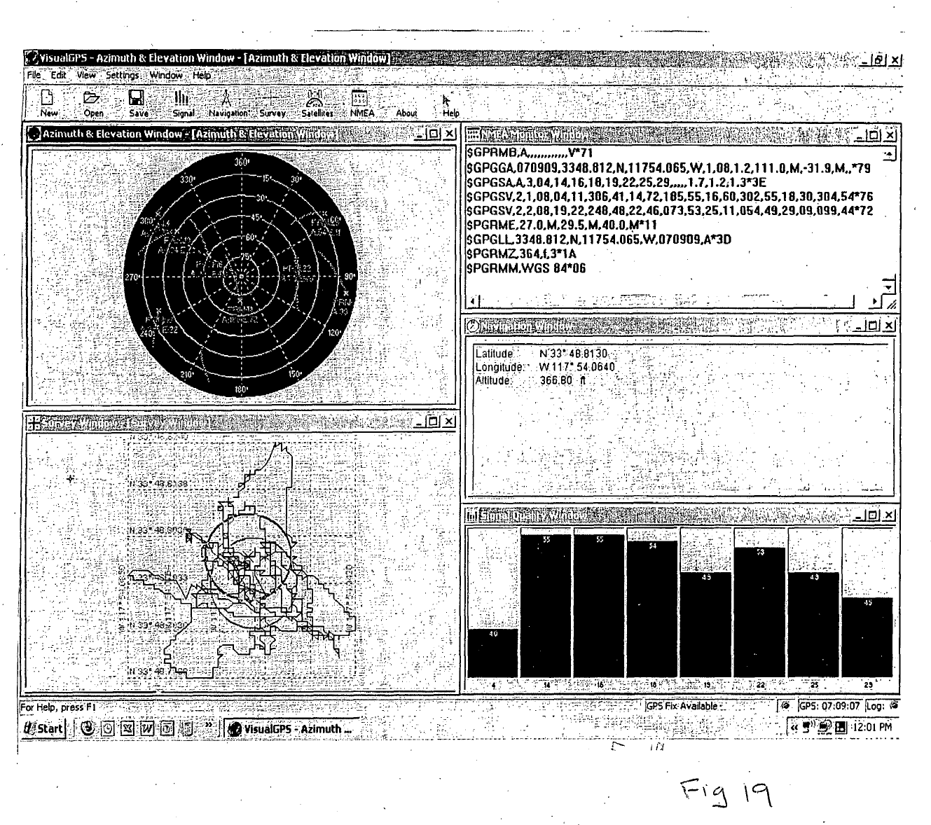

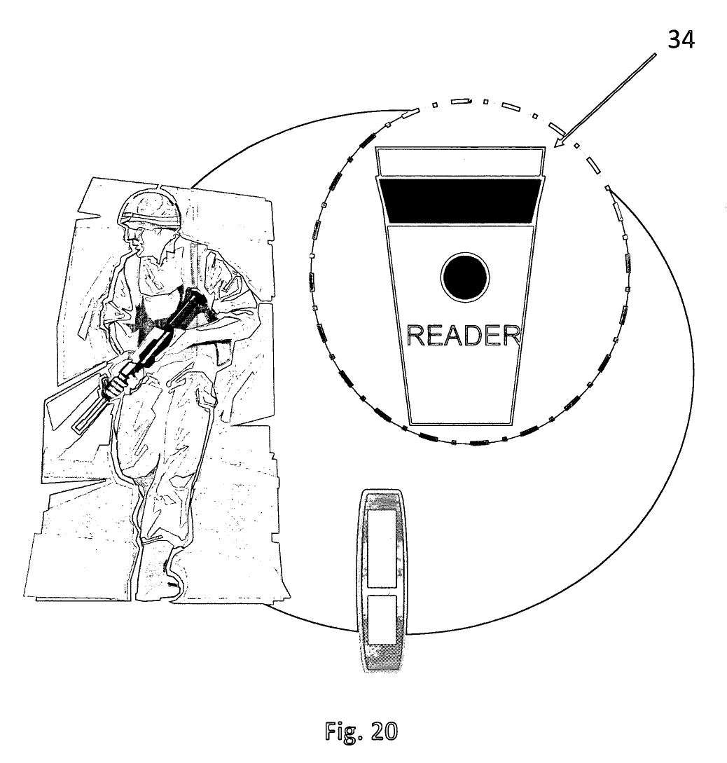

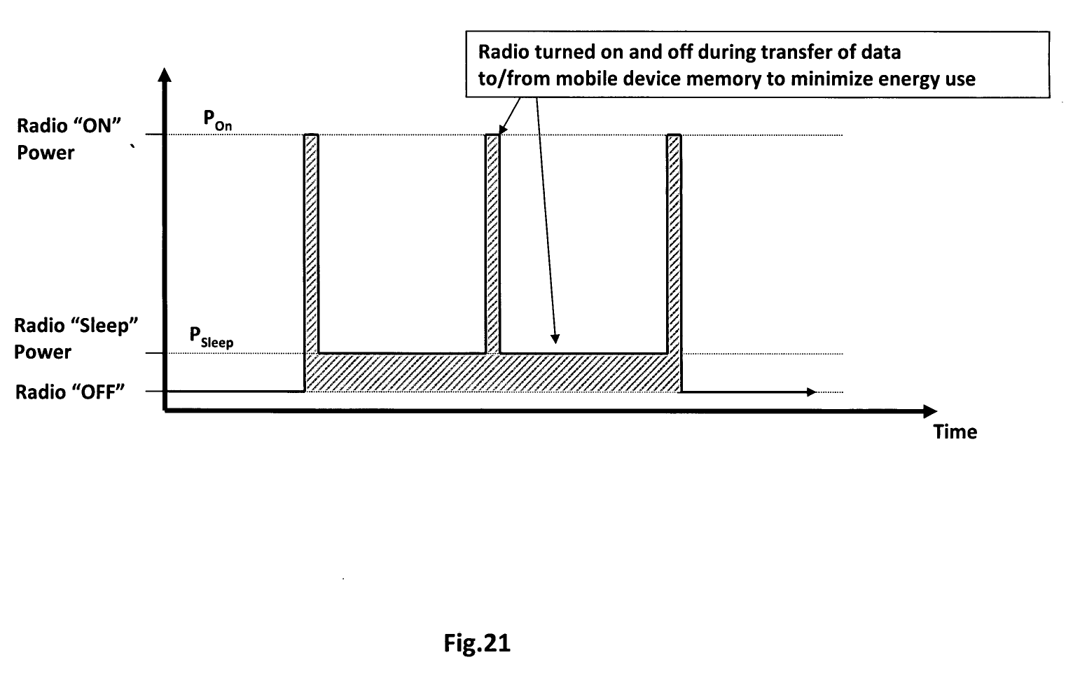

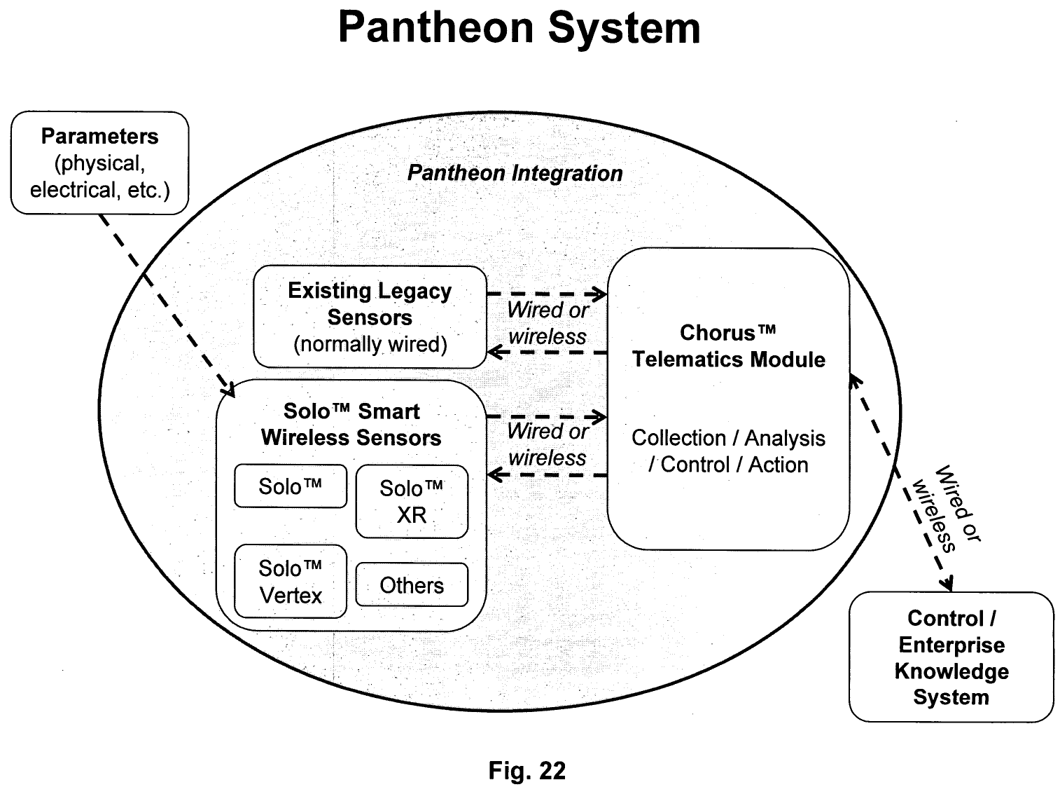

### DESCRIPTION OF THE EMBODIMENT(S)

Referring to the drawings, a communication system 30 according to the present invention is shown. It should be noted that the communication system 30, as shown in the drawings, is a diagnostic and telematic system 30 for use in vehicles 32 and handheld devices 34 within a battle field or military environment. However, it should be noted that the communication system 30, according to the present invention, is capable of being operated in any known vehicle system including but not limited to airplanes, spacecraft, marine vehicles, motor vehicles, unmanned vehicles, or personal devices held or used by individuals. It is also noted that it can be used and operated in any known system, not just harsh environments such as military systems or battle fields.

The communication system 30 of the present invention will connect vehicles 32 in real time with technicians and users at remote locations to communicate system help and repair status to the vehicles 32. The system 30 may operate on a two level mesh network 36, such that a micro mesh level will allow for infra or within the vehicle 32 sensing and a macro mesh level or inter for between vehicle sensing, that will allow for other networks features of the communication system 30 to collect, process, display, store and securely transmit information on platform operational status using FIPS, DES and AES compliance encryption methodologies.

The communication system 30 is a fully integrated hardware and software solution that may support many wireless communication protocols including but not limited to IEEE 802.15.4, Bluetooth, 802.11g, etc. The system 30 may use prognostic, diagnostic, and RFID/UID functionality that is built within the communication system 30 at the sensor level which may also allow for incorporation of remote re-programmability of the communication system 30 at the sensor level. The communication system 30 may include a plurality of devices that are capable of connecting to any legacy wired system sensor, gauge, and switch or wired vehicle network to work with existing hardware and provide a complete vehicle 32 picture to the user of the present invention communication system 30. It should also be noted that an open software architecture and plug and play hardware system will allow the system 30 to integrate seamlessly with existing systems, thus requiring minimal installation expertise in the field for the communication system 30 of the present invention. It should be noted that encryption, such as but not limited to AES FIPS 140-2 is available throughout for secure operation of the wireless sensors 40 within the communication system 30 of the present invention to ensure that the ability to update and conform to future military encryption standards is also within the ability of the communication system 30 according to the present invention. The communication or diagnostic/telematic system 30 of the present invention uses sensor technology with novel network topologies that may allow for both the sensor 40 and network technologies to be embedded within ultra rugged enclosures. The present invention uses a control hub 38 that may bridge wireless and wired networks, such as CAN and 802.11g wi-fi, and also coordinate with new and existing sensors and system management devices to provide greater functionality for wired and wireless sensor networks. The control hub 38 may also provide GPS 42 and accelerometer 44 based dead reckoning location data to the users of the network system. The accelerometer 44 based dead reckoning system is advantageous when GPS 42 is unavailable in urban or forested regions or under jamming conditions often found in military environments. The sensor modules 40 of the communication system 30 may natively measure temperature, vibration and three dimensional acceleration and may be connected to any existing sensor device, component or cluster known in present vehicles. The sensor modules 40 of the present invention may work with the control hub 38 to stream sensor data wirelessly across a secure network. The sensors 40 and control hubs 38 are integrated into a two level micro mesh and macro mesh network topology 36 that communicates via both wired and wireless paths within the vehicle 32, among vehicles 32 and portable hand held devices 34 such as a hand held maintenance device or any other known portable device.

The sensor modules 40 of the present invention include nodes that have the potential of operating on either wired or wireless networks, which makes the present invention ideal for both new vehicle platforms and legacy system upgrades of already existing vehicle networks. The ability of the present invention to utilize wireless sensor modules or nodes 40 where applicable for new sensing requirements will address critical issues related to placement flexibility and total vehicle weight. It should also be noted that when a wireless sensor module 40, according to the present invention is used, it may be placed anywhere on the vehicle, including but not limited to difficult to instrument external locations such as but not limited to remote planetary gear sensors, fluid sensor, purity sensors, black box sensors, man down human sensors, machine gun mounts, guns and other military equipment. Furthermore, the wireless sensor modules 40 may avoid the conventional wiring harnesses found in present day network environments within military vehicles that add both weight and lifecycle maintenance costs due to potential wear and subsequent signal failure when such wiring harnesses are compromised. It should also be noted that the present invention may use a battery powered wireless mesh mode.

The communication system 30 of the present invention generally includes four parts, however it should be noted that any other number of parts may also be used for the communication system 30 of the present invention. According to the present invention the communication system 30 includes a telematics control hub 38, at least one sensor module 40 arranged within the vehicle 32, a sensor control panel viewer device 46, and a distributed mesh network 36.

The telematics control hub 38 generally will be a small rugged and adaptable telematics and diagnostic hub that is capable of managing and analyzing multiple incoming wireless and wired network data streams to provide access to critical information. The control hub 38 of the present invention may also directly connect the sensors 40 and signals with its built in high speed analog to digital converter and coordinate with the vehicle sensors and system management devices to provide greater functionality for the wired and wireless sensor networks therein. The control hub 38 also is compatible with legacy systems and may allow for coordinated data management and analysis from multiple sensors 40 even adding time and location stamps to all received sensor data from either legacy or new wireless sensors 46 therein. The control hub 38 also may include a 12 bit, 8 channel analog to digital converter, an automotive grade signal conditioning device to accept legacy system input and convert it for use on the wireless digital network 36 of the present invention. It should be noted that the control hub 38 according to the present invention generally is a multiple antenna system which in one embodiment has two antennas. In the contemplated embodiment, one antenna will communicate with the wireless sensor modules 40 within the vehicle 32 while the other antenna will be used for obtaining GPS 42 data transmissions for the control hub 38 within the vehicle 32.

The control hub 38 may coordinate all sensor and vehicle network data within the communication system 30, as well as providing connectivity beyond the network system with optionally attached computer, telecommunications equipment and other devices such as but not limited to enterprise networks and satellite modems. The control hub 38 may maintain contact with both wired network sensors and the wireless network sensors 40 that are arranged within or near the vehicle 32. The control hub 38 may receive data from both types of sensors and attached devices for processing, while transmitting status, control and other data packets throughout the system 30 during operation thereof. The control hub 38 also may be able to provide local, non volatile storage for sensor and vehicle trip data including but not limited to fault codes, system health, and GPS positional data. The control hub 38 will integrate all of the functionality within the vehicle 32 to perform, sense and respond mission coordination and control within the mesh network 36 of wireless and wired network sensors, as well as being able to communicate directly with other control hubs 38 in a macro mesh network of other vehicles equipped with the communication system and associated sensor modules. The control hub 38 of the present invention may include a micro processor unit. In one contemplated embodiment the micro processor unit is a free scale MC5213 unit. The micro processor unit 50 may feature an advanced 32 bit RISC processor core optimized for portable, vehicular and other applications. The micro processor also may require low current consumption and high performance. The micro processor unit 50 of the present invention will incorporate a number of peripherals including high speed analog to digital converters, a CAN network interface, serial peripheral interfaces, counters and timers, on board flash and RAM and low power sleep and stop modes. However, it should be noted that any other known micro processing unit may also be used for the control hub 38. The control hub 38 also will include power supply circuitry that may incorporate over voltage and over current protection devices as well as inline ferrite beads and chokes to provide clean power to the internal circuitry of the control hub 38 even under typically harsh vehicle power system environments, such as those found in military environments. The control hub 38 may also feature dual DC/DC power converters which will enable uninterrupted operation from nine to 36 volts electric systems. The power supply 48 also will allow the control hub 38 to operate with an internally mounted back up battery option which will provide continuous operation even when the vehicle 32 or portable device power supply is turned off or inoperable. It is also contemplated that a self recharging battery may be used. The self recharging battery uses power harvesting techniques based on kinetic and inductive power generation using a standard cell form factor device.

The control hub 38 also uses a real time clock for keeping the local time and providing time stamping for data acquisition and control operations. In one contemplated embodiment a Dallas Semiconductor DS2417 real time clock is used. However, it should be noted that any other real time clock may be used. The real time clock will be able to synchronize with an attached GPS module 42 for accuracy. The real time clock also may be able to provide a highly accurate time base for the system in the event of a loss or jamming of the GPS signals.

The control hub 38 also may include a built in network support 50 for the two most widely used vehicle networks for heavy equipment, truck and military vehicle use. These include the J1939 CAN network support which will allow for the control hub 38 to communicate as a node on a wired CAN network or as a full CAN network controller in charge of all of the nodes of the communication network according to the present invention. This will allow the control hub 38 to operate as a stand alone CAN network within the communication system and sensor modules 40 in vehicles 32 with existing J1939 networks as well as permitting the easy installation of a new J1939 CAN network as an upgrade retrofit for vehicles not already so equipped.

The control hub 38 also may include a global positioning system 42 for direct connection to a GPS antenna through a rear mounted SMA RF connector to provide positional and time data derived from the constellation of GPS satellites in Earth orbit. In one contemplated embodiment, the control hub 38 may include a Trimble Lassen IQ GPS core unit 42. However, it should be noted that any other global positioning system may be used. The control hub 38 will be capable of requiring the GPS fix in as little as 30 seconds from power on. Furthermore, it should be noted that the GPS positional data and time data will be available for on system use as well as broadcast over the J1939 network support 50 using standard protocol as to provide GPS data to other nodes on the network.

The control hub 38 also may include a high speed USB 2.0 device interface 52 to directly connect the control hub 38 to an optional computer for control, data acquisition, and data base applications. When used in conjunction with the sensor control panel windows application the control hub 38 may be able to save all vehicle network and wireless sensor network data to a SQL server database in real time. Additionally, the communication system 30 of the present invention will have settings and program information set up using software that is provided therewith when connected to a PC over the supplied USB port. The control hub 38 may also include eight channels of high speed, 12 bit analog data acquisition that may be used in internal operations or streamed to external devices. The analog I/O interface is able to directly connect to any vehicle subsystem, including but not limited, knobs, switches, dials and sensors such as fuel level and speed without requiring any special interface circuitry or signal conditioning. The control hub 38 also may include a fully functional wireless sensor module device 40 as its wireless network interface. This wireless sensor module 40 as described hereafter, may include integrated XYZ accelerometers for vibration and inertial guidance purposes.

In one contemplated embodiment of the control hub 38 according to the present invention the hub is a small physical unit having a size of approximately 5″×4.75″×1.5″ and weigh approximately one pound depending on the configuration. However, it should be noted that any other sized control hub 38 may also be used depending on the design environment. The control hub 38 will be capable of operating anywhere between 9 to 36 volts DC unregulated with a UPS built in as a contemplated option. The power supply 48 may have less than 250 mA including GPS core system and will be able to supply regulated power to the external sensors and also may be capable of isolated supply and certain precondition optional conditions. The control hub 38 also may include a sealed Deutsch enclosure 56 with connectors and is capable of being submersible up to approximately three feet, however it should be noted that any other depth is also possible depending on the design requirements. The control hub 38 also has built-in flanges 58 for mounting to various parts of a vehicle or hand held device. The control hub 38 also may be capable of case cooling via convection of the outer surface to the environment as is and will be able to operate in any temperature range between approximately −40 C to +85 C. However, it is also contemplated to operate in a range much larger than that contemplated as described above. These extended temperature ranges can be designed via other cooling techniques other than convective cooling if a range greater than −40 C to +85 C is required. The control hub 38 may have an automatic boot by power on, internal timer or external interrupt. It also may be capable of powering down and being placed in sleep modes by a timer, by an external power down or by a programmable event designed into the system 30. The control hub 38 or sensor module 40 may also include a battery conserving slumber mode. The control hub 38 also may use flash drives for vibration resistance and R/W cycles for media dependent operation. The control hub 38 also is capable of using multiple processing architectures and is capable of expandable distributed processing support and also upgradeable across the board in its processing system. The control hub 38 also is capable of using SD flash memory 60 while it is also capable of using additional on chip and peripheral memory depending on the configuration required in the field. The control hub 38 also may operate on any known operating system, but in one contemplated embodiment Solidix or Linux is the preferred operating system. The control hub 38 also is capable of using remote pendant options along with voice text messaging, serial and USB ports ranging from anywhere from RS 2302, RS 485 or TTL serial ports or any known USB ports along with a DVI option to monitor output. The control hub 38 also may include vehicle computer components such that a vehicle body module with networking and discrete IO are standard features and that any analog and digital IO is capable of being used therewith. The control hub 38 also may include built in vehicle network support 54 for J1939, J1979, J1708, rollover and tilt sensors and yaw rate sensors. The control hub 38 may also have an optional programmable engine control unit or a programmable drive train control unit with all-wheel drive and traction control. It is also contemplated to have the control hub 38 with a drive by wire interface option arranged therein. The control hub 38 is also capable of providing an external sensor support via a wireless network 62 with any known standard but in one contemplated embodiment the 802.15.4, 802.11b/g, or Zigbee may be used. It is also capable of being wired with built in vehicle network via any RS 232, RS 485, TTL or Dallas 1 wire option. The control hub 38 also has a built in eight channel 12 bit fast analog to digital with automotive signal conditioning support option. It is also capable of supporting RTD input standards, PWM input standards, a 24 bit audio grade A/D option or any other additional discrete input option. Also, the control hub 38 is capable of communicating via any USB host interface, satellite and external radio interface may be built in, any wireless 802.15.4 interface built in and the 802.11b/g, any Bluetooth system or any other known communication systems. The control hub 38 also may have built in a vehicle networking communication hub such as J1939 CAN, J1979 CAN, J1708, OBD CAN, any known Ethernet interface, any Zigbee or NeuRFon complaint interface, a Dallas 1 Wire interface and a video interface option is also capable of being arranged within the control hub 38 according to the present invention.

The control hub 38 also may use any known diagnostics application software but one contemplated software is any known software front end with command language API such as asset network diagnostics, external world interface, J1939 wireless bridge, networked radio control, built in voltage measurement, test lead connector, a current jump connector, flash firm ware updates all capable of being operated on the control hub application. The control hub 38 is also capable of networking on any type of network and providing an easy and inexpensive path for future sensor upgrades for increasing system life extension in older vehicles. The control hub 38 also is capable of directly being connected to car and truck sensors, gauges and switches and can automatically generate OBD or 9139 CAN messages or any other known CAN network messages from any input and convert it to the data to operate on the network of the present invention.

The control hub 38 of the present invention generally has a vehicle network that in one embodiment is a J1939 vehicle sensor and control network and will provide some activity to the vehicle hardwire sensors without any bulky and failure prong vehicle wiring therein and it will complete all of this communication via wireless sensors. The system 30 also may use an isolated power supply that will allow for wide input voltage range power supply that works under low voltage conditions. The control hub 38 also has built in isolation protection systems that will protect it from power spikes and surges common in mobile installations. It should be noted that the SD card socket 60 may be capable supporting multi gigabyte secure digital cards for data and program storage, RFID, XML maintenance data base, black box flight recorder data and any other known information needed in the battle field. It should be noted that in one contemplated embodiment a cold fire core will be used in the communication system 30 and will provide a high speed 32 bit RISC super micro system that typically will combine PC desktop performance and high processing capabilities with advanced mobile IO co-processing platforms for integrated vehicle system management and onboard diagnostic and prognostics. The control hub 38 also may include a GPS core 42 or GPS rotation system module that will provide location based data, speed and altitude and snail trail options. An accelerometer 40 that may be used will be a solid state sensor that provides dead reckoning backup positional data in the event of loss of a GPS signal via a MEMS gyro. The accelerometers also may include inertial sensors that will assist dead reckoning computations and provide real time vibration analysis for vehicle system prognostics. The accelerometers generally operate on the XYZ planes. The system 30 may include voltage, temperature and clearance sensors that will provide instant status of a vehicle electrical and battery system. It is also contemplated that the system 30 may use a lithium ion battery to perform and supply power in the system and a rechargeable battery pack will allow the communication systems to operate during vehicle power down conditions if necessary. It should be noted that any other type of battery may also be used and that the lithium ion is just one contemplated embodiment. The accelerometer and MEMS gyros will compute the speed, heading and position of the vehicle and then transfer the dead reckoning information packet on the network for other systems to use in lieu of GPS data if the GPS is offline. Thus the present system 30 publishes this dead reckoning information instead of consuming it.

The control hub 38 also is capable of operating on any known network but in one contemplated embodiment a 802.11g/b network is used and will provide high speed wireless interface to any known PC's, LAN's and internet connections. It is also contemplated that an 802.15.4 sensor network may be used in the communication system 30 and will provide secure, robust wireless network connections to the sensor modules 40 of the present invention, remote pendants or hand held devices 36, displays and other communication system modules within the communication system 30. It should also be noted that a network bridge is also within the communication interface and may allow secure interoperability between wireless networks. This will allow the sensor network to be able to relay data to remote computers and networks using an 802.11g/wi fi interface. It should also be noted that it is contemplated that remote computers may be connected via 802.11g interfaces that may securely access and program sensor data or relay voice or text messages to hand held or remote devices via 802.15.4 protocol. The system 30 also can operate on USB 2.0 and RS 232 which will enable a direct wire connection between the control hub 38 and a PC. It should also be noted that any known PC software may be used with this system 30 such that console interfaces may allow the control hub 38 to be used with sensor control panel software for installation, command and control, system setup, SQL data bases and any other known third party software may be used via the open interface protocol of the control hub 38 and communication system 30. It should also be noted that the system prognostication routines may run in a background mode to continuously analyze sensor data and calculate system readiness, warn of impending system operating out of normal failure modes and compute system resources remaining at any time during operation thereof. The control hub 38 also may actuate the sensor modules 40 via a wake up message and will then instruct the sensor modules 40 to send data at a specified interval and if not recorded to have the sensor module 40 enter a slumber mode to conserve power. The control hub 38 may also route messages for one sensor 40 to another if the control hub 38 cannot directly transmit to a specific sensor. This will allow access to any sensor 40 which may otherwise be inaccessible. The control hub 38 may be capable of sending any known command or broadcast messages such as but not limited to slot setup, time offset, RF power, RF channel, assign ID, link quality, XTAL adjust, reset, version etc. These commands may set up network slots on the sensor 40, make adjustments to the sensors 40 time base, change the power of the RF transmitter or the RF channel of the RF transceiver of the sensor 40, associate a sensor 40 to a source ID, change the crystal calibration register in the sensor 40, reset a sensor 40, return the boot version of its firmware, etc. The control hub 38 also may concurrently sample sensor data via a specific command such that all sensors sample at the same time and send their data asynchronously back to the control hub 38 for reassembly as multiple concurrent data samples.

The communication system 30 also includes sensor modules 40 that operate with the control hub 38 and stream sensor data wirelessly across the secure network. In one contemplated embodiment the network is an 802.15.4 network. The sensor modules 40 generally form the core of the communication system 30 and provide any diagnostics and prognostic system requirements. The sensor modules 40 generally are compact, durable, embeddable and highly adaptable or capable of supporting a variety of sensor types and communicating wirelessly with any compatible device. In one contemplated embodiment, the sensor modules 40 are ultrasonically embedded solid state devices which will allow for ultra rugged and tamper proof operation. The sensors 40 also are capable of converting a legacy system into a state of the art wireless network nodes via connection thereto. The sensor modules 40 of the present invention have the ability to operate reliably when they are exposed to harsh environments which may disable prior art sensors, which would cause a ripple effect in the quality and timeliness of logistical and maintenance information on the battle field and any other harsh environment. The use of the present ultrasonic consolidation methodology which embeds unique RFID push and pull technology directly within the components targeted for a sensor operations, will securely send critical information to the logistics and tactical front and other high harsh environments. The ultrasonic consolidation sensors 40 are capable of being used in the sensor modules 40 may allow for the RFID push technology to be interoperable with standard RFID tabs and also will offer the additional advantage of making the sensors and tags highly tamper resistant to sabotage and the like. It is also contemplated to use sensor modules 40 that have specific power harvesting techniques and embedded antennas to allow for easy communication with the control hub 38 as described above.

In one contemplated embodiment the sensor modules 40 of the present invention are a wireless 802.15.4 mesh network wireless system that incorporates features that make it well suited for use in vehicular and industrial environments where wireless sensing and control applications may require low power real time connectivity to external devices such as temperature and voltage sensors. The sensor module 40 of the present invention is very small and has an ultra low power sensor control board with built in signal conditioning, analog to digital converters, XYZ accelerometers and high performance microprocessors for embedded applications and the like. In one contemplated embodiment, the sensor module 40 uses any known microprocessor unit wherein the contemplated embodiment has a free scale S08 MPU that performs the basic tasks of the unit including but not limited to data acquisition, and digital radio control for the sensor 40. The microprocessor core will provide high speed data processing capabilities along with ultra low power operation such that the sensor 40 may operate continuously on battery power for a predetermined amount of time without battery replacement. In one contemplated embodiment it is assumed that battery power may last for years without battery replacement. The micro processing unit also may serve as a secondary helper system when used in the control hub 38 to connect the control hub 38 to a GPS system 42 and other RTS peripherals. Each of the sensor modules 40 may have a sensor power supply section that features a three volt low drop linear regulator for direct connection to an unregulated DC supply or battery pack in another contemplated embodiment for low power operation. The LDO is able to operate the sensor at any voltage but approximately down to 1.8 volts is contemplated.

The sensor module 40 may include any known spread spectrum digital radio. In one contemplated embodiment a free scale MC13192 802.15.4 system is used. The digital radio may provide the physical link layer for the wireless sensor protocol used in the communication system 30 of the present invention. This digital radio must be able to operate in noisy, harsh and mobile environments. The radio also will incorporate encrypted direct sequence and frequency hopping spread spectrum technology for interference rejection, noise immunity and security from jamming or eavesdropping. The RF I/O strip arranged in the sensor module 40 of the present invention will provide a direct connection 50 Ohm low loss coaxial cable for direct connection to any 2.4 GHz antenna systems. However, it should be noted that any other known micro processing unit, power supply or digital radio may also be used in the present invention. The sensor module 40 also includes an analog input section that provides a direct connection to sensors such as but not limited to temperature sensors, discrete voltage, current operated DC sensor devices and controls. The analog I/O system also includes signal conditioning that allows for up to two externally mounted sensor devices. A system power supply monitor will allow for external monitoring of a power supply source voltage such as that which may be used to predict battery failure and charge/discharge characteristics of the vehicle. Each of the sensor modules 40 may also include a three axis MEMS accelerometer for vibration and inertial sensor applications such as but not limited to dead reckoning, shots fired detection, hit detection, road quality analysis, fluid quality analogs, black box data recording, vibration analysis for prognostics and diagnostics of moving parts and assemblies, navigation and any other known advanced applications. In one contemplated embodiment the accelerometer may be a free scale MMA 7260q device. It should also be noted that the accelerometer may be capable of being put in a sleep mode for ultra low power operation when continuous vibration monitoring is not required by the communication system 30.

In one contemplated embodiment a sensor module 40 may have the following technical parameters, however it should be noted that any other technical parameters may also be used for a sensor module 40 according to the present invention. One contemplated embodiment uses a sensor module 40 that is approximately 2.7″×0.7″×0.25″ and weighs under 1 oz depending on the configuration and enclosure in which it will be used. The sensor module 40 may be capable of operating at 9-36 volts DC unregulated, and have a UPS built-in as an option. They are also capable of operating on power less than 7 mA continuous and greater than 20 nA in sleep mode. They are also able to supply regulated power to external sensors, have an isolated supply as an optional line and a battery arranged thereon as an option. Each of the sensor modules 40 is capable of being sealed, tamper resistant within an aluminum or any other known metal enclosure, and have custom enclosures available that are made of any known material including but not limited to any metal, hard plastic, ceramic, composite, etc. Each of the sensor modules 40 are also capable of being submersible to a predetermined depth and in one contemplated embodiment the predetermined depth is approximately three feet. Each of the sensor modules 40 also may have built in orifices or holes therein for mounting to specific parts of a vehicle 32. The sensor modules 40 may reduce heat via convective case cooling and may be operated between approximately −40 C to +85 C depending on the operating environment. It is also contemplated that extended temperature ranges may be available with further engineering changes made thereto. Each of the sensor modules 40 may start up and shut down such that an automatic boot may occur at power on, by an internal timer or external interrupt may also turn the system on or off. The power down sleep mode may occur either via a timer, external power down or programmable event occurring therein. The sensor modules 40 may include memory and storage such as a built in flash memory for local storage along with optional expansion thereon and/or an additional on chip and peripheral memory depending on the configuration of the sensor module. The flash memory may be used as a “black box” data recording device to record data values for forensic analysis, etc. The data may be stored in any known way such as but not limited to a circular buffer, linear file, histogram, etc.

It is also contemplated that the sensor module 40 may have a sensor and communications support network that includes wireless with the 802.15.4 as a standard communication system and an 802.11b/g as optional thereon. It may also include support for wired technologies that include but are not limited to RS-232, RS-485, TTL, Dallas 1 Wire or the like. Each sensor module 40 may also have a built in 8 channel, 10 bit fast A/D with signal conditioning member, a built in 3 axis accelerometer, a built in yaw rate sensor, RTD inputs and PWM inputs are both standard. The sensor module 40 may also include 24 bit audio grade A/D as an option along with any additional discrete input option. It is also contemplated to have each sensor module 40 include a satellite and external radio interface built in along with a built in wireless 802.15.4 interface. It is also contemplated to have optional vehicle networking capability therein such as J1939 CAN, J1979 CAN, J1708 and an interface Ethernet option and also Zigbee and NeuRFon compliant connection options.

The sensor module 40 also is programmable or reprogrammable wirelessly or by a wire via the control hub 38. Any programming may be sent such as but not limited to timed or event driven conversions and reporting, sample rate, report rate, gain, filtration, signal conditioning, parsing, engineering units conversion, sensor linearization, firmware updates, and any known alarm conditions and responses. Each of the sensor modules 40 may also include built in RFID, UID, flight recording, programmable histogram bins. It is also contemplated that each sensor module 40 may have continuous or burst mode reporting, automotive or pre-programmed sensor mesh network topology configuration and wireless flash program memory updates therein.

The sensor module 40 may include a sensor input/output with a direct connection to vehicle sensors, a wireless network input/output that may operate on a secure 802.15.4 connection to the communication system network and subsystems. The system 30 also may have in one contemplated embodiment a lithium ion rechargeable battery power for unlimited sensor operation, however it should be noted that any other known type of battery may also be used. The system may also include programmable alarms that sends messages to the communication system when the programmable alarm condition is sensed and may also include RFID and flash memory thereon for bidirectional, push and pull, RFID communication that allows for system identification, status data, flight recording and maintenance logs and other system transfer capabilities. The sensor module 40 may have any known sensor arranged thereon such as a fluids purity sensor that may use a beam of light from any known source to penetrate the fluid across a gap to a photo diode for measurement such as fluid turbidity and particulate contamination. The sensor module 40 may also store an XML data file of a predetermined part/subsystem maintenance log on the part attached to the sensor 40. Hence, the log may be able to accompany the part during the service cycle. This will allow the maintenance personnel and the associated part to query the part itself for its own log. The sensor module 40 is capable of performing system failure analysis and prognostication at the sensor 40 without requiring host computer intervention which may allow for faster response and more accurate analysis.

The system 30 also may include a personal remote hand held device or any other type of device 34 that is capable of operating remotely from the vehicle 32 that is part of the communication system 30. The personal remote device 34 may include any known personal sized battery operated user interface input/output terminal, an LCD display that will provide system status, warnings and prognostics at a glance and a high contrast, day light readable and highly visible display. The device 34 is also capable of text messaging if needed. The personal remote device 34 also may include status LED's that are used with ultra bright LED indicators to flash the signal incipient failures, alarm conditions and incoming messages. It is also contemplated to have the personal remote device 34 include an audio speaker and a microphone that will provide secure voice over digital radio protocol for announcements, system status, prognostication, communications, voice annotation, emergency alarms, record, play and replay, voice messaging, or the like. The personal remote device 34 may also be capable of input time and displaying text data in any known matter. It is contemplated that the personal remote device 34 may operate on any secure wireless network such as an 802.15.4 system that may allow for connectivity to the communications system control hubs 38, sensors 40 and any other known sub systems. It is also contemplated that the personal remote device 34 may include a high efficiency solid state flashlight for personal use along with sensors that may monitor temperature and vibration or any other known sensor that may be capable of signaling a man down or status for remote monitoring by orientation, movement, etc.

The communication system 30 may also include a vehicle mounted display 64 that is capable of being mounted any where within the vehicle 32 for use by the occupants and users of the vehicle. The vehicle mounted display 46 generally is a large use interface input/output terminal that uses an LCD graphics display. However, it should be noted that any other type of vehicle mounted display 46 may also be used and it is not restricted to just the use of a LCD type display. The display 46 is capable of transferring system status, warnings and prognostics on a high contrast, daylight readable, highly visible display for the user in the vehicle 32. The vehicle mounted display 46 is capable of using ultra bright LED indicators to flash signal incipient failures or alarm conditions along with any other status needed to be known by the operator of the vehicle 32. The vehicle mount display 46 may also use secure voice over digital radio protocol for announcements, communications, voice annotation and emergency alarms along with any other information that is capable of being sent over audio speaker and microphone systems. The vehicle mounted display 46 is capable of operating in a secure connectivity environment with control hub 38 and other sub systems via any known wireless system but in one contemplated embodiment an 802.15.4 system is used. The display 46 is also capable of using LED area light which provides high efficiency programmable work light for the occupants of the vehicle 32.

The communication system 30 also includes a sensor control panel user interface 66 that may take all data that is collected on the platform via the communication system 30 via its control hub 38 and sensor modules 40 and allow the system to be stored in an XML database format that will be made available in real time to interested persons in the network environment. The viewing device for this data is any known standard sensor control panel 46 as described above. The standard sensor control panel 46 will have an interface 66 that will show remote observers the exact location and sensor status of any vehicle 32 along with vehicle identification and historical sensor data and any known remote personal hand held device 34 in real time.

The communication system 30 of the present invention may use a distributed mesh networking environment 36 that is capable of supporting a variety of network topologies. However, it should be noted that the current operational device for the network environment and communication system 30 may operate a two level mesh network 36. However, it should be noted that any other level network may also be used with the contemplated invention.

With the two level mesh network 36 of the present invention the network environment will operate at a micro mesh level and a macro mesh level. The micro mesh level will allow for individual sensors 40 and instrumented legacy devices to communicate intra or within the vehicle 32 to the control hub 38 of the communication system 30. This will provide real time platform operating status, and assist the vehicle operator's decision support and conditions. At the macro mesh level the communication system 30 may have its control hubs 38 communicate inter vehicle or between vehicles 32 and to remote hand held devices 34 or maintenance devices to provide access to platform records, technical data and maintenance schedules, simplify data entry to update platform records and enable automated data exchange with other vehicles 32 and portable maintenance devices 34. Additionally, the macro mesh level will allow for shared access to sparse external modem links and even to satellite and other GPS based systems. The micro mesh and macro mesh network features of the communication system may allow for collection, processing, displaying, storing and secure transmitting of information on platform operational status using any known FIPS compliant encryption thus allowing for secured communication on a battle field between any known vehicle either airborne, water based or land based, along with any personal hand held devices held by soldiers or the like in the harsh environments in which the communication system will operate.

It should be noted that the communication system 30 of the present invention that uses the ultrasonic consolidation method may allow for methodologies of ultrasonic solid-state bonding to grow rugged RF devices on existing components and vehicle structures to allow for a very rugged communication system 30 according to the present invention. It should also be noted that the communication system of the present invention may provide the first fully integrated hardware and software solution along with the telematics control hub 38 that will replace system computers of previous systems and provide greater functionality and rugged reliability for all wired and wireless sensors 40. It is also capable of operating with wireless remote devices for command and control, FIPS and DES encryption will be used throughout for secure operation of the wireless sensors 40. It should also be noted that the system 30 may provide prognostic, diagnostic, and functionality built in at the sensor level to improve efficacy and decrease system response time. The system 30 also may directly connect to any existing system sensor, gauge, switch and wired vehicle network to work with existing hardware. It is also capable of running as a stand alone operation or as a PC hosted system. The open software architecture will allow for integration with existing software such as XQL server and will be capable of easily adding additional wireless or network sensors as required.

It also be noted that the hand held devices 34 can be used as a war fire tracking device such that it includes a chip that is energized by a proprietary reader. In this device a small amount of radio frequency energy may pass from the scanner energizing a chip which then emits a radio frequency signal transmitting an individual holding the device 34 and unique personal verification number. The chip which is approximately the size of a small grain of rice may include a sub dermal radio frequency identification chip that can be used in a variety of security, financial emergency identification and other applications therewith. It is also contemplated to be used in connection with a UWB radio that is turned on and off to transfer packets of data. The on time is a function of data rate while the radio sleeps during data transfer to and from the hand set memory which will reduce energy consumed from the battery for a minimum amount thus allowing the communication system to operate at low power requirements.

The present invention has been described in an illustrative manner. It is to be understood that the terminology which has been used is intended to be in the nature of words of description rather than of limitation.

Any modifications and variations of the present invention are possible in light of the above teachings. Therefore, the present invention may be practiced otherwise than as specifically described.

What is claimed is:

1. A communication system for use within a vehicle, between vehicles and other remotely located devices, said system including:
a control hub for managing and analyzing multiple incoming wireless and wired data streams;
at least one sensor module wirelessly in communication with said control hub;
a sensor control panel interface for receiving information from said sensor module; and
a distributed mesh network for supporting at least two levels.

2. The system of claim 1 wherein said control hub having a high speed A/D converter.

3. The system of claim 1 wherein said control hub having a microprocessor unit, a power supply capable of operating on an internally mounted battery, and a real time clock.

4. The system of claim 1 wherein said control hub having a global positioning system and a wireless sensor said wireless sensor operates as a wireless network interface having an accelerometer for vibration and inertial guidance.

5. The system of claim 1 wherein said sensor modules stream data wirelessly to said control hub across said network in a secured environment.

6. The system of claim 1 wherein said sensor module having ultrasonically embedded sensors which are solid state devices for long lasting durable tamper proof operation.

7. The system of claim 6 wherein said sensor module having a RFID push and pull tag embedded therein, said RFID tag allows for secured transfer of information to and from said sensor module.

8. The system of claim 1 wherein said sensor module having a small size, low power control board thereon, said board having built in signal conditioning, A/D connecter, accelerometers and a high performance microprocessor therein.

9. The system of claim 8 wherein said accelerometer is a three axis accelerometer for vibration and inertial sensor applications.

10. The system of claim 1 wherein said distributed mesh network having a micro mesh level and a macro mesh level.

11. The system of claim 10 wherein said micro mesh level operates between said sensor modules, between said sensor modules and said control hub and between instrumented legacy devices and said control hub to provide real time platform operating status.

12. The system of claim 10 wherein said macro mesh level includes said control hub communications to the other control hubs and portable devices to provide access to records and technical data.

13. A diagnostic and telematic system for use within a vehicle, between vehicles and other remotely located devices, said system including:
a control hub arranged within each vehicle of the system;
at least one wireless sensor module arranged in each vehicle and in communication with said control hub of said respective vehicle;
a sensor control panel interface for receiving information from said sensor module; and
a distributed two level mesh network.

14. The system of claim 13 wherein a plurality of sensor modules are arranged in each vehicle.

15. The system of claim 13 wherein said sensor modules having remote re-programmability and having prognostic, diagnostic and RFID/UID functionality therein.

16. The system of claim 13 wherein said control hub having a high speed A/D converter.

17. The system of claim 13 wherein said control hub bridges wireless and wired systems including legacy in vehicle systems.

18. The system of claim 17 wherein said control hub communicates with portable devices to provide real time information to a user.

19. The system of claim 13 wherein said control hub having a global positioning system and at least one accelerometer, said accelerometer provides back up dead reckoning location data.

20. The system of claim 13 wherein said sensor modules having ultrasonically embedded sensors therein, said sensor modules having a built in signal conditioning, power supply, digital radio, microprocessor, and an accelerometer.

21. The system of claim 20 wherein said accelerometer having three axes for vibration and material applications, said applications include dead reckoning, shots fired detection, hit detection, fluid analysis, road quality analysis, vibration analysis for prognostics and diagnostics of moving parts, moving assemblies and navigation.

22. The system of claim 13 wherein said two level network having a macro mesh level and a micro mesh level.

23. The system of claim 22 wherein said macro mesh level is communication between said sensor modules and instrumented legacy devices and said control hub within one vehicle to provide real time operating status, said macro mesh level having said control hubs communicating between vehicles and to portable devices and to provide shared access to external links.

24. A method of communicating between multiple vehicles and multiple sensors in each of the vehicles, said method including the steps of:
installing a control hub in each vehicle;
installing wireless sensors in each vehicle;
networking said control hub and said wireless sensors in a multi level environment; and
coordinating in real time all data received by said control hub from said wireless sensors in the vehicle and information from remote portable devices and other vehicles.

25. The method of claim 24 further including the step of controlling and a network of wireless and wired sensors.
